(19) United States
(12) Patent Application Publication
(10) Pub. No.: US 2006/0132449 A1
(43) Pub. Date: Jun. 22, 2006

(54) System, apparatus, and method for displaying variable legends on key buttons

(75) Inventor: Carlos Alberto Pironio, Raleigh, NC (US)

Correspondence Address: LENOVO (US) IP Law, Mail Stop ZHHA/B675/PO Box 12195, 3039 Cornwallis Road, RTP, NC, 27709-2195, US

(73) Assignee: International Business Machines Corporation, Armonk, NY (US)

(21) Appl. No.: 11/018,128

(22) Filed: Dec. 21, 2004

(51) Int. Cl. G09G 5/00

(52) U.S. Cl. 345/172

(57) ABSTRACT

A keyboard includes a number of key buttons, each of which is mounted to move vertically above a display panel, such as an LCD. Each of the key buttons includes a transparent central portion, through which an area of the display panel is viewed. A computer system drives the display panel to produce variable legends, indicating the characters that will be added to a document being generated in response to the depression of the key buttons as a function of an operating state of the computer system. The computer system may additionally be programmed to display information provided by the user to indicate the functions assigned by the user to the key buttons.

### BACKGROUND OF THE INVENTION

1. Field of the Invention

This invention relates to visually displaying variable legends indicating multiple uses of key buttons, more particularly, to displaying such legends on the key buttons themselves, and to a computer system having a keyboard with key buttons on which visual legends are displayed in a programmable and interactive manner.

2. Summary of the Background Art

Various key buttons on a typical computer keyboard are each used for several different purposes, depending on the application program that is being run in the computer system and additionally on the particular context in which the program is being used. For example, when a particular application program is running, the context in which the keyboard is used can be changed by depressing a combination of additional keys, such as a shift key, a control key, and an alternate key, together with one of the key buttons representing a letter or number or another functional key. While a degree of uniformity among most, if not all, programs executing with one of the versions of the Microsoft WINDOWS® operating system, has been established for the functions associated with certain of the key combinations, many other key combinations have a number of different meanings, depending on the particular application program that is running. One reason for this is that different types of application programs, such as word processing programs, graphics programs, and data base programs place different requirements on the keyboard interface. Furthermore, many application programs provide a facility through which the user can assign his own meanings to various key combinations.

A single user may use a single computer system with a number of different application programs, so that the depression of certain keys and combinations of keys has several different meanings. Thus, what is needed is a method of displaying the meaning of various individual key buttons in terms of the present context of operation of a computer system.

Furthermore, the meaning of various individual key buttons may be changed to provide different characters or symbols. Such changes may be limited to a few special symbols within a character set, such as replacing the dollar sign with the symbol for the British pound, or to providing a several additional characters required by another language. Alternately, a more extensive set of symbols may be provided for use in a specialized application, such as typing a musical score or a mathematical equation. The alphabetic characters may be further changed to provide for a language, such as Greek, Hebrew, or Arabic, using a different character set.

Manufacturers of computer systems and other devices employing keyboards have faced a need to provide keyboards having a number of different legends for use with the various languages of the world. Thus, what is needed is a simple method for changing the display of legends on key buttons for use with different languages, so that the production of multiple types of keyboards is no longer required.

Furthermore, in many countries, multiple languages are in common use, so that a single computer system may be used to produce documents written in different languages. Additionally, a single computer system may be used for applications requiring different character fonts, such as word processing and writing mathematical equations. Thus, what is needed is a method for changing the legends of key buttons to represent different character fonts that may be accessed within a computer system.

One method for providing legends relating to key button functions has been the use of templates configured to be placed atop a keyboard adjacent the buttons with legends describing the functions of particular key buttons in a particular context, such as operation of the computer system with a particular application program. However, the use of such templates has been limited by the fact that a single template often cannot represent the number of meanings that can be assigned to a single key button as several different application programs are used. Additionally, such a template cannot anticipate the various meanings that can be assigned by a user to various key buttons. Furthermore, since the key buttons of a typical keyboard are closely spaced, the legends printed on such a template can only lie adjacent the key buttons extending around the periphery of the pattern of key buttons, with even the area around this periphery often being unavailable for template placement in the keyboards of portable computer systems.

The patent literature includes a number of descriptions of an individual key button having a transparent upper surface and a display screen, such as an LCD mounted within the key button. For example, such key buttons are described in U.S. Pat. Nos. 5,712,661, 5,818,361, 6,004,049, 6429,855, and 6,014,131. However, such an approach has a disadvantage of requiring a number of electrical connections to be made between the key button, which must move downward when it is depressed, and the stationary base of the keyboard. For example, with a liquid crystal display (LCD), a light source, such as a light emitting diode (LED) must be placed within the key button to provide a source of illumination by which graphical information can be read, and electrical connections must be made both to the LED and to the LCD to provide for the display of varying graphical images. If all of the buttons on a typical computer keyboard are provided with individual display screens in this way, the cost of the cabling and individual circuit driving elements can become high, and the number of electrical conductors extending to each key button can be expected to adversely affect the feeling associated with the depression of the button. In this regard, it is understood that a great deal of effort has been applied to the design of conventional computer keyboards to provide an optimum feeling accompanying key depression, with designs providing for a level of spring resistance that is reduced by the buckling of a spring mechanism as the key button is depressed. What is needed is a mechanism providing for display of variable graphical data on individual key buttons without requiring the attachment of each key button by means of a significant number of electrical conductors.

U.S. Pat. No. 4,551,717 describes a programmable key for use on a terminal having a microchip device incorporated therein to permit programming the function of the key, and one or more LCDs tp indicate the programmed function of the key. The key button is mounted to move vertically relative to a stationary display which is seen through the transparent top portion of the key button, so that the problem s associated with moving electrical conductors extending to the display are alleviated. However, the LCD is limited to a small device, incorporated in a space within a cylindrical portion of the key button, which extends downward into the base of the programmable key to operate a switch. Because a separate LCD is required for each button built in this way, a relatively high cost can be expected to be associated with providing a relatively large number of key buttons, such as all of the key buttons of a typical computer keyboard. Thus, what is needed is a method for providing a number of key buttons with variable graphical images from a single LCD.

A number of patents describe display panels extending adjacent to key buttons to display variable graphical information relating to the use of the buttons. For example, U.S. Pat. Nos. 5,181,029 and 5,181,361 describe an LCD display panel extending adjacent the function keys placed along the upper row of a typical computer keyboard. U.S. Pat. No. 5,712,661 describes a display screen having openings through which buttons protrude, with information regarding an individual button being displayed in the display panel area around the button. However, since the key buttons of a standard computer keyboard are placed close together, such information can only be placed adjacent the key buttons extending along the periphery of the key button pattern.

U.S. Pat. No. 5,612,692 describes a backlighted full travel, sealed keyboard, in which a translucent membrane, disposed between the keys and a printed circuit board includes a gasket around its perimeter that is sealingly engaged by q housing for the keyboard. The keyboard is backlighted with LEDs disposed on the printed circuit board. What is needed is a keyboard having keys with legends that can be changed instead of merely illuminated.

Other patents describe methods for displaying key button graphics on the conventional display screen of a computer system or other electronic device. For example, such methods are described in U.S. Pat. Nos. 5,124,940, 5,128,672, 5,525,978, 5,825,362, 5,867,729, 5,986,586, and 6,029,628. Such methods do not provide close physical correlation with all of the keys buttons of a keyboard, and the space required to display key button graphics can interfere with outer uses of the display screen.

### SUMMARY OF THE INVENTION

In accordance with one aspect of the invention, apparatus is provided including a number of key buttons, a support structure, a number of resilient members, a number of transducers, and a display screen. Each of the key buttons, which are mounted to move vertically within the support structure, includes a transparent central portion. Each of the resilient members holds one of the key buttons upward within the support structure. Each of the transducers produces an electrical signal in response to downward movement of one of the key buttons. The display screen extends under each of the key buttons to provide changeable display patterns visible through the central portion of each of the key buttons.

The display screen may be a transilluminated liquid crystal display (LCD) or a plasma display. Preferably, the support structure includes a number of elongated segments extending under a peripheral portion of each of the key buttons, and an aperture extending under the central portion of each key button. The display screen and the resilient members may form integral portions of an elastomeric structure.

The keyboard may be part of a computing system including data and instruction storage and a microprocessor. The data and instruction storage stores a plurality of data structures, wherein each of the data structures includes data representing a plurality of characters to be written to a document in response to depressing one of the key buttons with the computer system in a particular state of operation. The microprocessor is programmed to determine a particular state of operation of the computer system, to select a data structure corresponding to the particular state of operation of the computer system, and to generate a visual pattern to be displayed on the display screen under each of the key buttons from data corresponding to the key button stored within the data structure corresponding to particular state of operation of the computer system.

### BRIEF DESCRIPTION OF THE FIGURES

FIG. 1 is a fragmentary plan view of a keyboard built in accordance with a first embodiment of the invention;

FIG. 2 is a fragmentary cross-sectional elevation of the keyboard of FIG. 1, taken as indicated by section lines 2-2 therein;

FIG. 3 is a fragmentary cross-sectional elevation of an electrode structure within the keyboard of FIG. 1;

FIG. 4 is a schematic view of a transducer producing a voltage signal in response to key button movement in the keyboard of FIG. 1;

FIG. 5 is a fragmentary plan view of a keyboard built in accordance with a second embodiment of the invention;

FIG. 6 is a fragmentary cross-sectional elevation of the keyboard of FIG. 5, taken as indicated by section lines 6-6 therein;

FIG. 7 is a fragmentary cross-sectional elevation of an electrode structure within the keyboard of FIG. 5;

FIG. 8 is a fragmentary plan view of a keyboard built in accordance with a third embodiment of the invention;

FIG. 9 is a fragmentary cross-sectional elevation of the keyboard of FIG. 8, taken as indicated by section lines 9-9 therein;

FIG. 10 is a fragmentary cross-sectional elevation of the keyboard of FIG. 8, taken as indicated by section lines 10-10 therein;

FIG. 11 is a graphical view of the force required to displace the dome portions of an elastomeric structure within the keyboard of FIG. 8 by downward movement of a key therein;

FIG. 12 is a schematic view of a transducer producing a voltage signal in response to key button movement in the keyboard of FIG. 8;

FIG. 13 is a schematic view of alternative apparatus for producing electrical signals in response to the depression of key buttons within a keyboard built in accordance with the invention;

FIG. 14 is a block diagram of a computing system including a keyboard built in accordance with the invention;

FIG. 15 is a flow showing process steps occurring during execution of a keyboard display subroutine in the computing system of FIG. 14; and

FIG. 16 is a flow showing process steps occurring during execution of a keyboard programming subroutine in the computing system of FIG. 14.

### DETAILED DESCRIPTION OF THE INVENTION

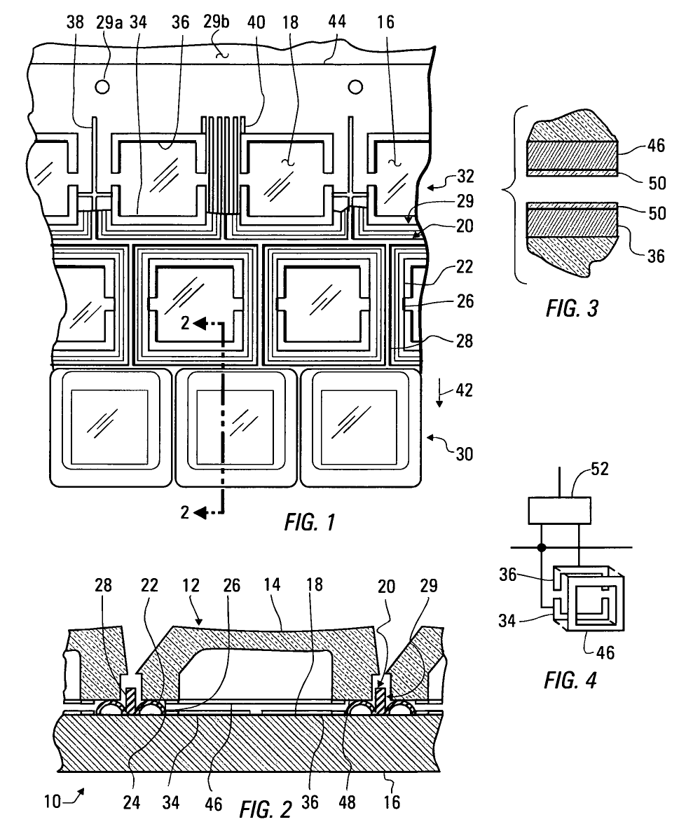

A keyboard 10 built in accordance with a first embodiment of the invention will now be discussed, with reference being made to FIGS. 1-3. FIG. 1 is a fragmentary plan view of the keyboard 10, while FIG. 2 is a fragmentary cross-sectional elevation thereof, taken as indicated by section lines 2-2 in FIG. 1, and while FIG. 3 is a fragmentary cross sectional elevation of an electrode structure therein. The keyboard 10 includes a number of key buttons 12, each of which includes a transparent central portion 14. The key buttons 12 extend above a display screen 16, which is configured to display graphics upwardly in a manner allowing a graphical pattern to be seen from above through each of the transparent central portions 14 of the key buttons 12. For example, the display screen 16 is a liquid crystal display (LCD) that is transilluminated by a light source shining upward from a lower surface of the LCD or a plasma display.

The individual key buttons 12 are movably fastened above an upper surface 18 of the display screen 16 by means of an elastomeric structure 20 including a resilient member 22 in the form of a hollow rib extending as a frame below a peripheral portion 24 of each of the key buttons 12. The elastomeric structure 20 also includes an aperture 26 extending from the inner edges of the resilient member 22 under the central portion 14 of each of the key buttons 12, allowing the display screen 16 to be clearly viewed through the central portion 14. For example, the peripheral portion 24 of each of the key buttons 12 is adhesively attached to the underlying resilient member 22 of the elastomeric structure 20, with the resilient member 22 holding the key button 12 upward, spaced away from the display screen 16, providing resistance to the downward movement of the key button 12, and returning the key button 12 upward when it is released following downward movement. The elastomeric structure 20 also includes a central rib 28, which supports the adjacent resilient members 22 and the adjacent key buttons 12, which may slide along the rib 28 while remaining in attachment to a resilient member 22. The central rib 28 and adjacent portions of the resilient member 22 form elongated segments 29 of the elastomeric structure 20, extending between adjacent apertures 26 and under the peripheral portions 24 of the key buttons 12. In the example of FIG. 1, the elastomeric structure 20 extends outwardly from the display screen 16 to be held in position by a number of pins 29a extending upward from a housing 29b.

In FIG. 1, the keyboard 10 is shown as cut away to reveal levels of internal structure. The key buttons 12 as shown only in a lower row of positions 30, while the elastomeric member 20 is also shown as being cut away from an upper row of positions 32. The display screen 16 includes a first electrode 34 and a second electrode 36 extending under the peripheral portion 24 of each of the key buttons 12. All of the first electrodes 34 are electrically connected to a common point by means of a conductive land structure 38 extending along the upper surface 18 of the display screen 16, while each of the second electrodes 36 is connected to an individual point by means of an individual land structure 40 also extending along the upper surface 18. For example, in a typical computer keyboard having six rows of key buttons 12, including a rear row of function keys and a front row including the space bar and Alt and Ctrl mode keys, the second electrodes 36 under the rearmost three rows of key buttons 12 are reached by sets of six individual land structures 40 extending in the forward direction of arrow 42 from a rear edge 44 of the display screen 16 under the peripheral portions 24 of adjacent key buttons 12. Similarly, the second electrodes 36 under the forwardmost three rows of keys are reached by sets of six individual land structures (not shown) extending opposite the direction of arrow 42 from a front edge (not shown) of the display screen 16.

Each of the key buttons 12 includes a third electrode 46 extending in an annular pattern along a lower surface 48 of its peripheral portion 24. FIG. 3 is an enlarged cross-sectional view showing the electrodes 34, 46, which are composed of conductive materials, being covered by insulating layers 50.

FIG. 4 is a schematic view of a transducer producing an electrical signal in response to the depression of one of the key buttons 12 of the keyboard 10. The first electrode 34 is connected to a voltage level, which may be electrical ground, along with other first electrodes 34 within the keyboard 10 and to an input to a detection circuit 52. The second electrode 36 is connected to provide another input to the detection circuit 52. The detection circuit 52 senses changes in capacitance between the first and second electrodes 34, 36 as the third electrode 46 is moved downward toward the first and second electrodes 34, 36, by depressing the key button 12 and as the third electrode 46 moves away from the first and second electrodes 34, 36 with the release of the key button 12 to move upward. The detection circuit produces an output signal indicating when the key button 12 is depressed and when it is released. Suitable circuits for sensing capacitance changes of this kind are well known to those skilled in the art of designing circuits for capacitive keyboards.

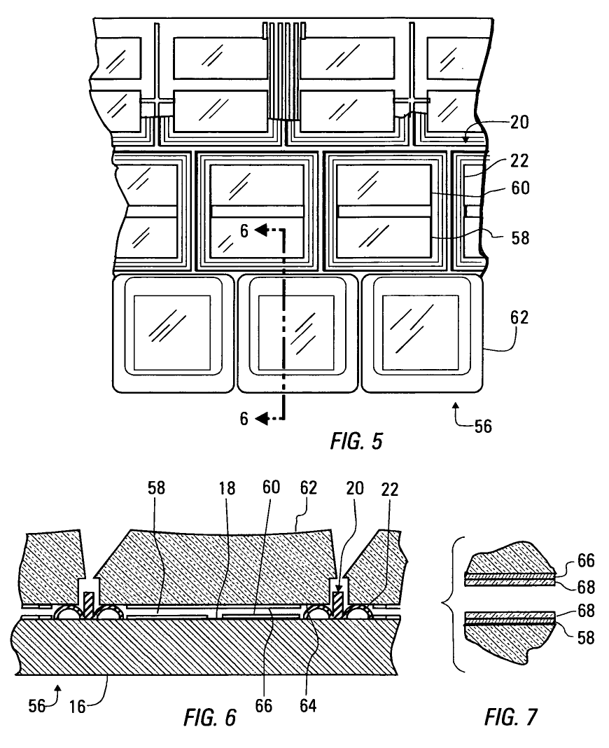

A keyboard 56 built in accordance with a second embodiment of the invention will now be discussed, with reference being made to FIGS. 5-7. FIG. 5 is a fragmentary plan view of the keyboard 56, while FIG. 6 is a fragmentary cross-sectional elevation thereof, taken as indicated by section lines 6-6 in FIG. 5, and while FIG. 7 is a fragmentary cross section of an electrode structure therein. The keyboard 56 includes a display screen 16 and an elastomeric structure 20, which, being similar or identical to corresponding structures within the keyboard 10 discussed above in reference to FIGS. 1-3, are therefore accorded like reference numbers. In the example of FIG. 5, the elastomeric structure 20 is shown as being adhesively attached to the display screen 16.

However, in the keyboard 56, the first electrode 58 and the second electrode 60 are formed as transparent conductive coatings applied to the upper surface 18 of the display screen 16. While these electrodes 56, 58 are understood to be transparent, they are shown in FIG. 5 as being bounded by solid lines so that their shape can be understood. Each of the key buttons 62, which is adhesively attached to the underlying resilient member 22 of the elastomeric structure 20, includes a flat lower surface 64, along which a transparent conductive coating is applied to form a third electrode 66. As shown in FIG. 7, each of the electrodes 58, 60, 66, includes an outer electrically insulating coating 68. Electrical connections to the first and second electrodes 58, 60 of the keyboard 56 are similar to the connections to the first and second electrodes 34, 36 of the keyboard 10, and the depression and release of each of the key buttons 62 may similarly be detected by a detection circuit 52, as explained above in reference to FIG. 4.

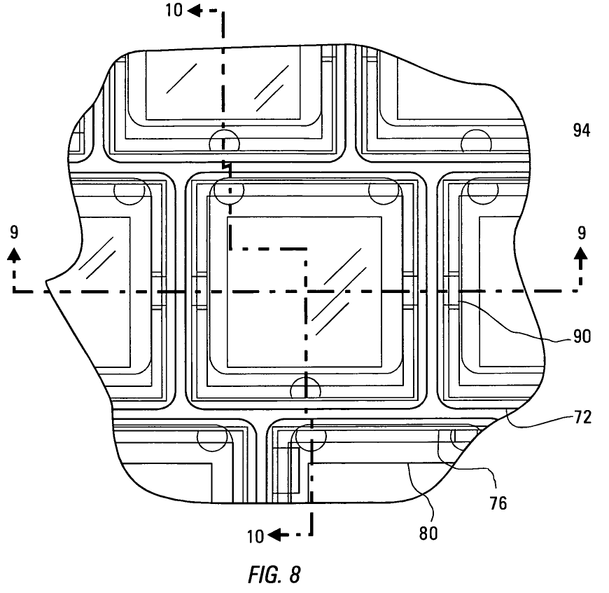

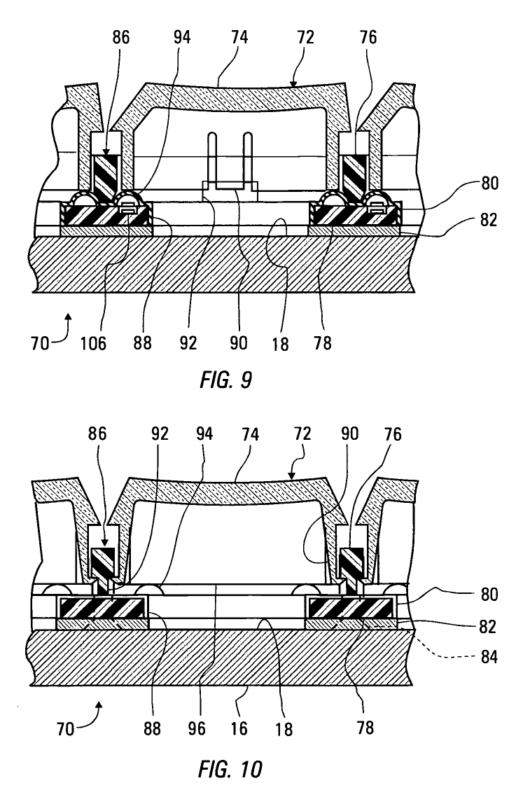

A keyboard 70 built in accordance with a third embodiment of the invention will now be discussed with reference being made to FIGS. 8-10. FIG. 8 is a fragmentary plan view of the keyboard 70, while FIG. 9 is a fragmentary cross-sectional elevation thereof, taken as indicated by section lines 9-9 in FIG. 8, and while FIG. 10 is another cross-sectional elevation thereof, taken as indicated by section lines 10-10 in FIG. 8. The keyboard 70 includes a display screen 16, which, being similar or identical to corresponding structure within the keyboard 10 discussed above in reference to FIGS. 1-3, is therefore accorded a like reference number.

The keyboard 70 additionally includes a number of key buttons 72, each of which has a transparent central portion 74. The key buttons 72 are mounted to move vertically within a rigid guiding structure 76 that is attached to a rigid support structure 78, to an elastomeric structure 80, and additionally to a circuit board 82 by heat staking a number of pins 84 extending downward as portions of the guiding structure 76. The guiding structure 76, the support structure 78, the elastomeric structure 80, and the circuit board 82 together form elongated segments 86 extending between apertures 88 through which portions of the upper surface 18 of the display screen 16 are visible through the central portions 74 of the key buttons 72. Each of the key buttons 72 includes a pair of latching members 90 sliding vertically within slots 92 of the guiding structure 76 to hold the key button 72 in engagement with the guiding structure 76. The key button 72 is installed within the guiding structure 76 by being pressed downward to deflect the latching members 90 inward.

The elastomeric structure 80 includes three dome portions 94 extending upward to contact a peripheral lower surface 96 of each key button 72.

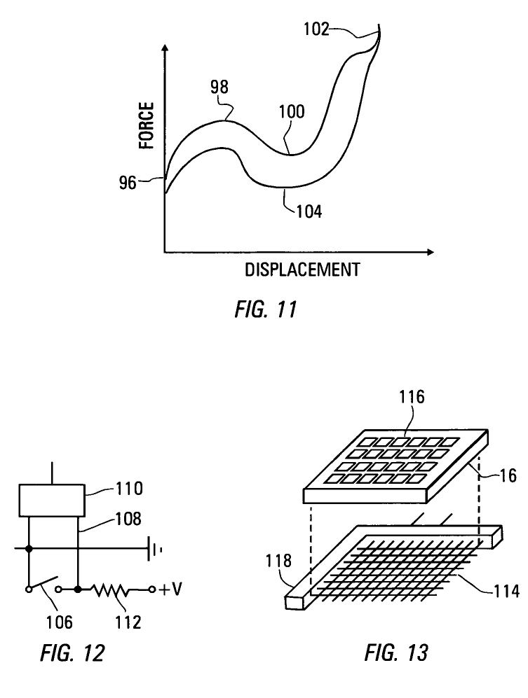

FIG. 11 is a graphical view of the force required to displace the three dome portions 94 downward as a function of the downward movement of the key button 72. The force begins at an initial level 96 required to begin movement from the undeflected position shown in FIG. 10, increasing to a level 98, and then decreasing with additional downward movement to a level 100 as the dome portions 94 collapse. The force then increases again to a level 102 as the key button 72 is moved into its fully depressed position. As the key button 72 is returned upward, the force provided by the three dome portions 72 follows a similar pattern indicated by a curve 104, with lower levels of force occurring due to hysteresis. The reduction in force between the levels 98 and 100 provides a satisfying feeling that the key button 72 has been properly depressed, making typing on the keyboard 70 easier.

In the examples of FIGS. 8-10, three dome portions 94 are used with each key button 72 to center the point at which force is applied to move the key button 72 straight downward. Alternatively, only one or two dome portion 94 may be used, together with an additional means restricting the angle at which the key button 72 is moved, such as a track or a U-shaped bail that pivots with downward movement while holding the key button 72 aligned with its pivot points.

Referring again to FIG. 9, one of the three dome portions 94 under each key button 72 extends above a pair of electrical contacts 106, which are held together as the key button 72 is held down. Circuit lands (not shown) extending along the circuit board 82 carry signals from these contacts 106 to circuits removed from the display screen 16.

FIG. 12 is a schematic view of a transducer producing an electrical signal in response to the depression of one of the key buttons 72 of the keyboard 70. An input 108 to a voltage detector 110 is held at the level of a biasing voltage +V through a resistor 112 as the contacts 106 are held open. When the key button 72 is depressed to close these contacts 106, the input 108 is driven to electrical ground, causing the voltage detector 110 to produce a signal indicating that the key button 72 has been depressed.

FIG. 13 is a schematic view of another form of apparatus for producing electrical signals in response to the depression of key buttons within a keyboard built in accordance with the invention. Liquid crystal displays have been incorporated in a number of touch sensitive panels producing electrical indications of pressure or of a local change in capacitance through a sensing grid of conductors. In the example of FIG. 13, such a sensing grid 114 is placed below the display panel 16, measuring a change in capacitance caused by a key button moving an electrode 116 downward above the display panel 16 as the key button is depressed, with voltage levels on the sensing grid being determined within circuits 118. Alternately, the sensing grid 114 may be incorporated within the display panel 16. In either case, a portion of the sensing grid 114 acts as a part of a transducer detecting movement of a key button above it.

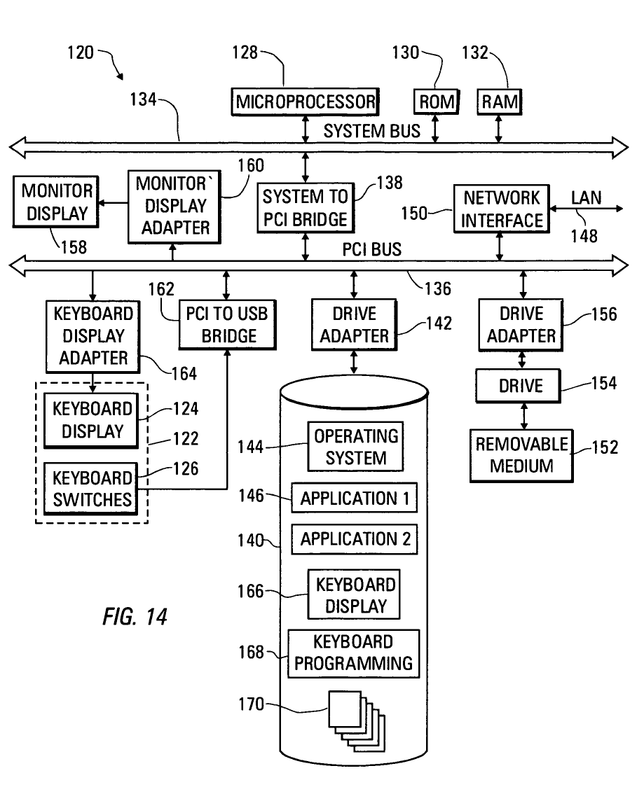

FIG. 14 is a block diagram of a computing system 120 including a keyboard 122 built in accordance with the invention to include a keyboard display screen 124 and keyboard switches 126 providing electrical signals indicating the depression of an individual key button. For example, the keyboard 122 may be the keyboard 10 described above in reference to FIGS. 1-4, the keyboard 56 described above in reference to FIGS. 5-7, or the keyboard 70 described above in reference to FIGS. 8-12. Alternately, the keyboard 122 may incorporate features from various keyboards described above, having, for example, electrodes producing a change in capacitance in the manner of keyboard 10 and resilient members in the form of dome portions of an elastomeric structure in the manner of the keyboard 70.

The computing system 120 additionally includes a number of conventional elements, such as a microprocessor 128, a read-only memory 130 storing instructions executed during an initialization process following power-on, and a random access memory 132, storing instructions to be executed within the microprocessor 128. The read-only memory 130 and the random access memory 132 are connected to the microprocessor through a system bus 134. The system bus 134 is also connected to a PCI (Peripheral Component Interconnect) bus 136 by means of a system to PCI bridge circuit 138. Data and instruction storage 140 is connected to the PCI bus 136 by means of a drive adapter 142. For example, data and instruction storage 140 is provided within a hard disk drive, while the drive adapter 142 is a hard disk adapter. Data and instruction storage 140 stores data and instructions for an operating system 144 and for one or more applications 146. The operating system 144 is loaded for execution within the microprocessor 128 to manage the operations of other programs, such as the applications 146 within the computing system 120. The applications 146 perform requests for services of the computing system 120 through application program interfaces (APIs) provided by the operating system 144.

Data and instructions may be downloaded from a LAN (local area network) 148 in the form of computer data signals including computer usable code embodied in a carrier wave, with the signals being converted to drive the PCI bus 136 within a network interface circuit 150, providing data and instructions stored within data and instruction storage 140. Alternately, computer usable data and instructions stored on a removable computer readable medium 152 may be read within a drive 154 and transmitted through the PCI bus 136 by means of a drive adapter 156 for storage within data and instruction storage 140.

A user interface is provided through a monitor display 158, which may be a conventional device driven from the PCI bus 136 through a monitor display adapter 160, and through the keyboard 122, with user inputs being provided through the keyboard switches 126, and with system outputs to the user being provided through the monitor display 158 and through the keyboard display 124. The keyboard switches 126 are connected to the PCI bus 136, for example, through a PCI to USB bridge 162, with the keyboard switches 126 forming a USB (Universal Serial Bus) device. The keyboard display 124 is connected to the PCI bus 136 through a keyboard display adapter 164. User interface features may also be provided by additional conventional devices (not shown), such as a mouse or other pointing device and a printer.

The computing system 120 operates in several particular states, each of which determines the set of characters that will be written to a document being created within the computing system 120 in response to the depression of various key buttons within the keyboard 122. The particular operating state of the computing system 120 may be determined by the application program 146 executing within the computing system 120. For example, one word processing application program may be loaded to execute for preparing documents in English, while another word processing is loaded to execute for preparing documents in Spanish. Additionally, the particular operating state of the computing system may be determined by the depression of a combination of one or more control key buttons. For example, an application program 146 may be programmed to add mathematical symbols to the document being generated upon the depression of a key button within the keyboard 122 as the Alt control key button is held depressed.

In accordance with a preferred version of the invention, data and instruction storage 140 additionally stores instructions and data for a keyboard display subroutine 166 and for a keyboard programming subroutine 168, together with a number of data structures 170. The keyboard display subroutine 166 causes graphical information to be displayed on the keyboard display 124, while the keyboard programming subroutine 168 provides a means for the user to specify the graphical information to be displayed on the keyboard display 124 under specified conditions. Each of the data structures 170 stores data describing a number of patterns to be displayed on the keyboard display 124 with the computer 120 in a particular operating state.

The character set to be added to a document in response to the depression of the key buttons of the keyboard 122 may be determined in part by the operating system 144, by the application 146 and by user actions. For example, both the operating system 144 and the application 146 may support the use of special symbols that can be accessed through the keyboard 122, in the form of mathematical symbols, in the form of typographic symbols, and in the form of characters from other languages, such as Greek characters or characters with diacritical markings. The user can choose among several character sets through the depression of one or more control keys along with an alphanumeric key, or through the choice of one application program 146 over another. With many applications 146, the user can specify a combination of control keys, such as the Ctrl, Alt, and Shift keys, to be depressed together with an alphanumeric key to cause a particular symbol to be printed. With many applications 146, the user can additionally specify a combination of control keys to be depressed together with an alphanumeric key or a function key to cause a specific function, specified by creating a macro using a sequence of key strokes and selections, to be performed.

The keyboard display 124 provides a number of positions in which graphical information or legends are displayed for viewing through the individual key buttons of the keyboard 122. There may be one such position for each key button within the keyboard 122, or such positions may be provided for only a subset of the buttons within the keyboard 122. In either case, each of the data structures 170 preferably includes a record for each of these positions, with data being stored in the form of an alphanumeric character or symbol, in the form of a combination of alphanumeric characters or symbols, or in the form of a bit map describing the graphical information. Some of the records may be blank, indicating, for example that a character will not be printed, or that an action will not be performed, if a certain combination of key buttons is depressed.

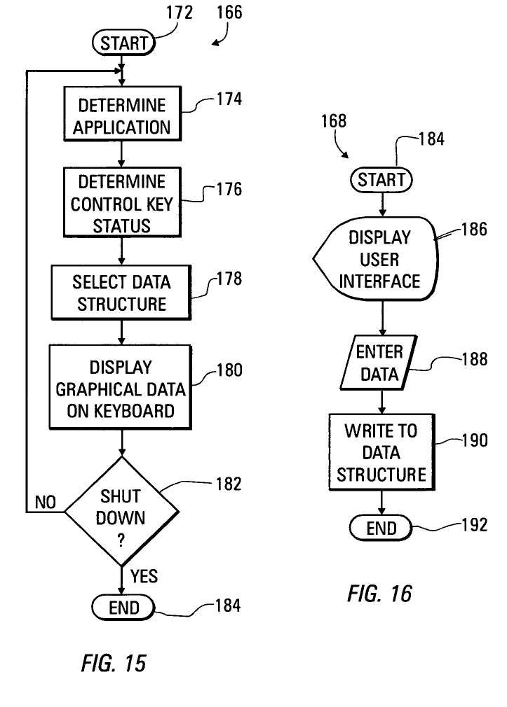

FIG. 15 is a flow chart indicating process steps occurring during execution of the keyboard display subroutine 166. Preferably, this subroutine 166 operates within a multitasking environment whenever the computer system 120 is being used, starting in step 172 when the operating system 144 is booted and ending in step 174 when the computer system 120 is shut down. The various determinations of this subroutine 172 are made on a periodic basis, so that the data displayed on the keyboard display 124 is changed in a timely manner. After starting in step 172, the subroutine 166 proceeds to step 174, in which a determination is made of which application 146 is executing. Then, in step 176, a further determination is made of which control keys, if any, are depressed. Next, in step 178, one of the data structures 170 is selected, based on the determination of the particular operating state of the computing system 120 made in steps 174 and 176. Next, in step 180, the graphical data stored within the data structure 170 selected in step 178 is displayed on the keyboard display 124. Then, in step 182 a determination is made of whether the computer system 120 is being shut down. If it is, the subroutine 166 is ended in step 174; otherwise the subroutine 166 returns to step 174 for periodic performance of the steps 174 through 182.

FIG. 16 is a flow chart indicating process steps occurring during execution of the keyboard programming subroutine 168, which starts in step 184, preferably after being called by a subroutine within an application 146 used to determine a user-specified action to be performed in response to the depression of a combination of key buttons on the keyboard 122. After starting in step 184, the subroutine 168 displays a user interface graphic in step 186 including a prompt to enter data describing a function to be performed. For example, this graphic may be a dialog box indicating the combination of key buttons that has been depressed, while providing a text box for data to be entered for subsequent display upon the depression of the same combination of key buttons. Then, in step 188, data is entered by the user using the keyboard 122, with the process of data entry being ended by the depression of the Enter key button. For example, the user may enter a two- or three-character sequence reminding him of the function to be performed in response to depressing the combination of key buttons. Then, the data entered in step 188 is written to a data structure 170 in step 190, with the data structure corresponding to the combination of key buttons depressed and to the application 146 calling the subroutine 168. Then, the subroutine ends in step 190, returning to the calling application 146.

Alternately, the subroutine 168 may be started in step 184 in response to a user selection of an icon, so that data can be written to represent a function being performed in response to the depression of a combination of key buttons.

While the invention has been described in terms of preferred versions or embodiments with some degree of particularity, it is understood that this description has been given only by way of example, and that many variations can be achieved without departing from the spirit and scope of the invention, as described in the appended claims.

What is claimed is:

1. Apparatus comprising:
a plurality of key buttons, wherein each of the key buttons includes a transparent central portion;
a support structure mounting each of the key buttons to move vertically;
a plurality of resilient members, wherein each of the resilient members holds one of the key buttons upward within the support structure;
a plurality of traducers, each producing an electrical signal in response to downward movement of a key button in the plurality of key buttons;
a display screen extending under each of the key buttons and under the support structure to provide changeable display patterns visible through the central portion of each of the key buttons.

2. The apparatus of claim 1, wherein the display screen includes a liquid crystal display.

3. The apparatus of claim 2, wherein the liquid crystal display is transilluminated.

4. The apparatus of claim 1, wherein the display screen includes a plasma display.

5. The apparatus of claim 1, wherein the support structure includes a plurality of elongated segments extending under a peripheral portion of each key button and a plurality of apertures extending under the central portion of each key button.

6. The apparatus of claim 5, wherein the support structure and the resilient members form integral portions of an elastomeric structure.

7. The apparatus of claim 5, wherein
the support structure is formed as a rigid member,
the apparatus additionally includes an elastomeric structure extending along the plurality of elongated segments, and
the plurality of resilient members form portions of the elastomeric structure.

8. The apparatus of claim 1, wherein each of the transducers includes:
first and second electrodes extending along an upper surface of the display screen in a spaced-apart relationship under the key button;
a third electrode extending along a lower surface of the key button;
and a circuit sensing a change of capacitance between the first and second electrodes as the third electrode is moved downward toward the first and second electrodes and generating an electrical signal indicating depression of the key button.

9. The apparatus of claim 8, wherein
the third electrode extends along at least a portion of the lower surface of a peripheral portion of the key button, and
the first and second electrodes are disposed under portions of the third electrode.

10. The apparatus of claim 8, wherein
the first, second, and third electrodes are transparent and electrically conductive,
the third electrode extends along at least a portion of the lower surface of the central portion of the key button, and
the first and second electrodes are disposed under portions of the third electrode.

11. The apparatus of claim 1, wherein each of the transducers includes:
a pair of switch contacts closed by downward movement of the key button; and
a circuit producing an electrical signal in response to closing the pair of switch contacts.

12. The apparatus of claim 1, wherein each of the transducers includes:
a portion of a conducive grid extending under the key button; and
a circuit measuring voltage levels on the conductive grid in response to movement of an electrode attached to the key button.

13. The apparatus of claim 1, additionally comprising a housing having a plurality of pins disposed outwardly from the display panel, wherein the support structure extends outwardly from the display panel to provide a plurality of holes extending around the pins to hold the support structure in position extending across the display panel.

14. A computer system comprising:
a keyboard including a plurality of key buttons, each including a transparent central portion, a support structure mounting each of the key buttons to move vertically, a plurality of resilient members, each holding one of the key buttons upward within the support structure, a plurality of transducers, each producing an electrical signal in response to downward movement of one of the key buttons, and a display screen extending under each of the key;
data and instruction storage storing a plurality of data structures, wherein each of the data structures includes data representing a plurality of characters to be written to a document in response to depressing one of the key buttons with the computer system in a particular state of operation;
a microprocessor programmed to determine a particular state of operation of the computer system, to select a data structure corresponding to the particular state of operation of the computer system, and to generate a visual pattern to be displayed on the display screen under each of the key buttons from data corresponding to the key button stored within the data structure corresponding to particular state of operation of the computer system.

15. The computer system of claim 14, wherein the microprocessor is programmed to determine the particular state of operation of the computer system by a method including determining which application program is executing within the computing system.

16. The computer system of claim 15, wherein the method additionally includes determining a combination of control key buttons being depressed.

17. The computer system of claim 14, wherein the microprocessor is additionally programmed to perform a method including:
displaying a user interface including a prompt to enter data describing a function to be performed in response to depressing a combination of key buttons within the keyboard including a key button within the plurality of key buttons;
receiving input data entered by depressing key buttons on the keyboard; and
storing data in one of the data structures to represent the input data.

18. The computer system of claim 17, wherein the user interface including a prompt to enter data describing a function to be performed is displayed in response to a determination that the user has defined a function to be performed in response to determining that a combination of key buttons is being depressed.

19. The computer system of claim 17, wherein the user interface including a prompt to enter data describing a function to be performed is displayed in response to a determination that a displayed icon has been selected.

20. A method for providing a user interface indicating multiple uses of a plurality of key buttons within a computer system, wherein the method includes:
maintaining a plurality of data structures within data storage, wherein each of the data structures includes data representing a plurality of characters to be written to a document in response to depressing a key button within a plurality of key buttons in a keyboard with the computing system in a particular state of operation;
determining a particular state of operation of the computer system;
selecting a data structure corresponding to the particular state of operation of the computer system; and
generating a visual pattern to be displayed on the display screen under each of the key buttons from data corresponding to the key button stored within the data structure corresponding to the particular state of operation of the computer system.

21. The method of claim 20, wherein a determination of the particular state of operation of the computer system includes determining which application program is executing within the computer system.

22. The method of claim 21, wherein the determination of the particular state of operation of the computer system additionally includes determining a combination of control key buttons being depressed.

23. The method of claim 20, additionally comprising:
displaying a user interface including a prompt to enter data describing a function to be performed in response to depressing a combination of key buttons within the keyboard including a key button within the plurality of key buttons;
receiving input data entered by depressing key buttons on the keyboard; and
storing data in one of the data structures to represent the input data.

24. The method of claim 23, wherein the user interface including a prompt to enter data describing a function to be performed is displayed in response to a determination that the user has defined a function to be performed in response to determining that a combination of key buttons is being depressed.

25. The method of claim 23, wherein the user interface including a prompt to enter data describing a function to be performed is displayed in response to a determination that a displayed icon has been selected.

26. A computer readable medium having computer usable code stored thereon causing a processor to perform a method for providing a user interface indicating multiple uses of a plurality of key buttons within a computer system, wherein the method includes:
maintaining a plurality of data structures within data storage, wherein each of the data structures includes data representing a plurality of characters to be written to a document in response to depressing a key button within a plurality of key buttons in a keyboard with the computing system in a particular state of operation;
determining a particular state of operation of the computer system;
selecting a data structure corresponding to the particular state of operation of the computer system; and
generating a visual pattern to be displayed on the display screen under each of the key buttons from data corresponding to the key button stored within the data structure corresponding to the particular state of operation of the computer system.

27. The computer readable medium of claim 26, wherein a determination of the particular state of operation of the computer system includes determining which application program is executing within the computer system.

28. The computer readable medium of claim 27, wherein the determination of the particular state of operation of the computer system additionally includes determining a combination of control key buttons being depressed.

29. The computer readable medium of claim 26, wherein the method additionally comprises:
displaying a user interface including a prompt to enter data describing a function to be performed in response to depressing a combination of key buttons within the keyboard including a key button within the plurality of key buttons;
receiving input data entered by depressing key buttons on the keyboard; and
storing data in one of the data structures to represent the input data.

30. The computer readable medium of claim 29, wherein the user interface including a prompt to enter data describing a function to be performed is displayed in response to a determination that the user has defined a function to be performed in response to determining that a combination of key buttons is being depressed.

31. The computer readable medium of claim 29, wherein the user interface including a prompt to enter data describing a function to be performed is displayed in response to a determination that a displayed icon has been selected.

32. A computer data signal embodied in a carrier wave including computer usable code causing a processor to perform a method for providing a user interface indicating multiple uses of a plurality of key buttons within a computer system, wherein the method includes:
maintaining a plurality of data structures within data storage, wherein each of the data structures includes data representing a plurality of characters to be written to a document in response to depressing a key button within a plurality of key buttons in a keyboard with the computing system in a particular state of operation;
determining a particular state of operation of the computer system;
selecting a data structure corresponding to the particular state of operation of the computer system; and
generating a visual pattern to be displayed on the display screen under each of the key buttons from data corresponding to the key button stored within the data structure corresponding to the particular state of operation of the computer system.

33. The computer data signal of claim 32, wherein a determination of the particular state of operation of the computer system includes determining which application program is executing within the computer system.

34. The computer data signal of claim 33, wherein the determination of the particular state of operation of the computer system additionally includes determining a combination of control key buttons being depressed.

35. The computer data signal of claim 32, wherein the method additionally comprises:
displaying a user interface including a prompt to enter data describing a function to be performed in response to depressing a combination of key buttons within the keyboard including a key button within the plurality of key buttons;
receiving input data entered by depressing key buttons on the keyboard; and
storing data in one of the data structures to represent the input data.

36. The computer data signal of claim 35, wherein the user interface including a prompt to enter data describing a function to be performed is displayed in response to a determination that the user has defined a function to be performed in response to determining that a combination of key buttons is being depressed.

37. The computer data signal of claim 35, wherein the user interface including a prompt to enter data describing a function to be performed is displayed in response to a determination that a displayed icon has been selected.
